(19) United States
(12) Patent Application Publication
(10) Pub. No.: US 2026/0304239 A1
(43) Pub. Date: Oct. 1, 2026

(54) PDU SET HANDLING DURING MOBILITY

(71) Applicant: InterDigital Patent Holdings, Inc., Wilmington, DE (US)

(72) Inventors: Rocco Di Girolamo, Laval (CA); Michael Starsinic, Newtown, PA (US); Magurawalage Chathura Madhusanka Sarathchandra, London (GB); Xavier De Foy, Kirkland (CA); Srinivas Gudumasu, Montreal (CA); Michel Roy, Candiac (CA); Kevin Di Lallo, Laval (CA)

(73) Assignee: InterDigital Patent Holdings, Inc., Wilmington, DE (US)

(21) Appl. No.: 19/092,661

(22) Filed: Mar. 27, 2025

(51) Int. Cl. H04W 36/00; H04L 5/00; H04W 36/30; H04W 76/20; H04W 76/30

(52) U.S. Cl. CPC H04W 36/0033; H04L 5/0053; H04W 36/30; H04W 76/20; H04W 76/30

(57) ABSTRACT

A source base station may transmit, to a target base station, a handover request message including protocol data unit (PDU) set context information for a wireless transmit/receive unit (WTRU) and receive, from the target base station, a handover request acknowledge message. The source base station may transmit, to the WTRU, an radio resource control (RRC) reconfiguration message. The source base station may receive from a network node at least one PDU of a PDU set intended for the WTRU. The source base station may transmit the at least one PDU to the target base station based on the PDU set context information and monitoring of the PDU set performed by the source base station. The source base station may receive, from the target base station, a context release message for the WTRU and release a context for the WTRU.

### BACKGROUND

Work is being done for 3rd Generation Partnership Project Fifth Generation (5G) architecture to support Extended Reality (XR) and Media (XRM) services. XRM services may be characterized by high data rate and low latency to provide immersive video and audio experiences for users. A work item in 3GPP Release 18 identified 5G System (5GS) functionality and capability enhancements for XRM. Capability enhancements for XRM may include multi-modality transmission, 5GS information exposure, protocol data unit (PDU) set-based quality of service (QoS) handling, uplink-downlink transmission coordination, packet delay variation monitoring and reporting, and power saving enhancements. A second XRM work item has commenced in 3GPP Release 19 to identify further enhancements to (5GS) functionality, including enhancements to PDU set handling, handling of end-to-end encrypted XRM traffic, and Differentiated Services Code Point (DSCP) marking enhancements leveraging PDU Set QOS information.

### SUMMARY

Mobility handling procedures for user data with PDU sets intended for a WTRU are disclosed herein. A source base station may transmit, to a target base station, a handover request message including protocol data unit (PDU) set context information for the WTRU. The source base station may receive, from the target base station, a handover request acknowledge message. The source base station may transmit, to the WTRU, an radio resource control (RRC) reconfiguration message. The source base station may receive, from a network node comprising a user plane function (UPF), at least one PDU of a PDU set intended for the WTRU. The source base station may determine to relay the at least one PDU to the target base station based on the PDU set context information and monitoring of the PDU set performed by the source base station. The source base station may transmit, to the target base station, the at least one PDU. The source base station may receive, from the target base station, a context release message for the WTRU. The source base station may release a context for the WTRU in response to the received context release message.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a flow diagram illustrating an example intra-system handover procedure 200 using an Xn interface;

FIG. 3 is a flow diagram illustrating an example procedure for handling protocol data unit (PDU) sets during the phases (pre-handover, interruption, relaying, and post-handover) of a handover procedure;

FIG. 4 is a flow diagram illustrating an example mobility handling procedure for user data with PDU sets;

FIG. 5 is a flow diagram illustrating another example mobility handling procedure 500 for user data with PDU sets;

FIG. 6 is a flow diagram illustrating another example mobility handling procedure for user data with PDU sets intended for a WTRU, which may be performed by a source base station; and

FIG. 7 is a flow diagram illustrating another example mobility handling procedure for user data with PDU sets intended for a WTRU, which may be performed by a target base station.

### DETAILED DESCRIPTION

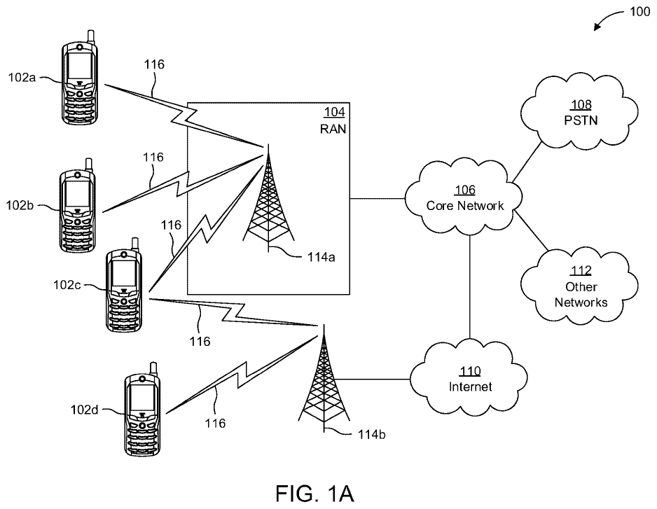

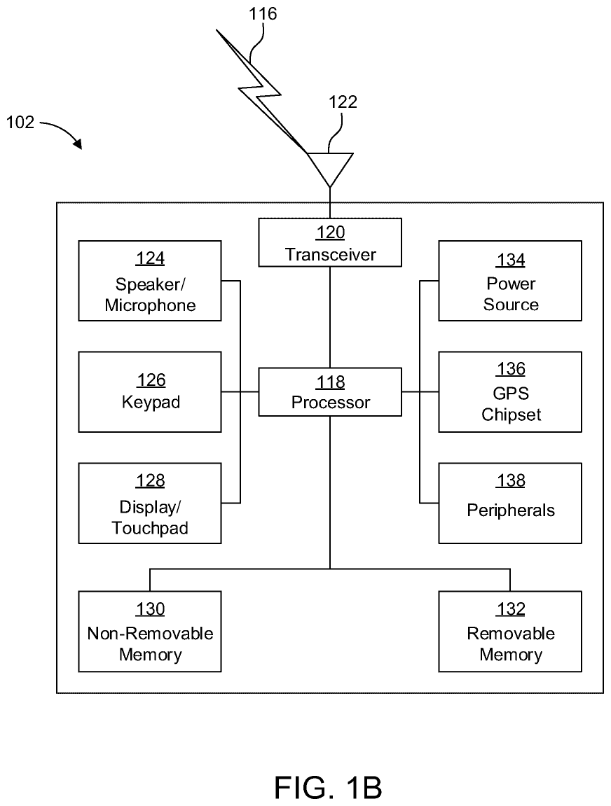

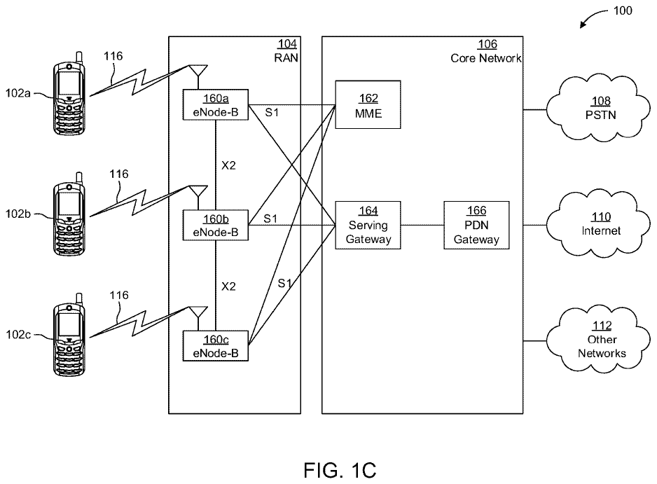

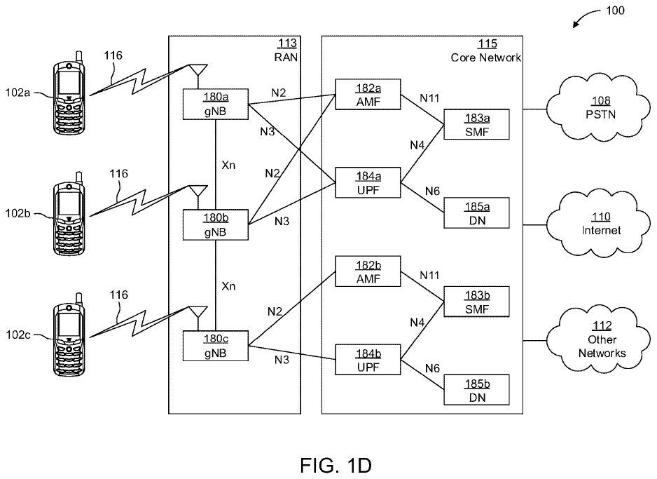

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114 b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A handover may include one or more of the following phases: pre-handover phase, interruption phase, relaying phase, and/or post-handover phase. Example procedures for handling a protocol data unit (PDU) set during a handover are disclosed herein. Example procedures include methods to determine PDU set handling to apply (or enforce) for a PDU set, and the assistance information that may be used to make this determination. Example procedures further include methods to perform PDU set monitoring for PDU sets that are split between source RAN node (e.g., base station) and a target RAN node (e.g., base station). Example procedures further include procedures performed by a user plane function (UPF) upon receiving an indication that a WTRU is unreachable as a result of a handover. Example procedures further include methods to determine which PDUs of a PDU set may need to be relayed from a source RAN node to a target RAN node during a handover procedure.

Example procedures for source RAN node (source base station) handling of PDU sets during a handover are disclosed herein. In an example, a source RAN node may receive a quality of service (QoS) profile with an indication of the PDU set mobility option to use. The source RAN node may evaluate when to trigger a handover for a WTRU, based on measurement reports, radio resource management) RRM information, and the indication of the PDU set mobility option to use. The source RAN node may send a handover request message to the selected target RAN node, and the handover request message may include PDU set context information. The source RAN node may receive a handover request acknowledge message from the target RAN node. The source RAN node may send a pending handover message to the user plane function (UPF) (e.g., in the user plane, or in the control plane via the access and mobility management function (AMF)). The source RAN node may send an RRCReconfiguration message to the WTRU. The source RAN node may receive a PDU of a PDU set and evaluate whether to relay the PDU to the target RAN node. The evaluation may be based on the PDU set monitoring over the source RAN node, the PDU set quality of service (QoS) parameters, and/or the PDU set information.

The source RAN node may receive a WTRU context release message from the target RAN node and may release context for the WTRU. The PDU set mobility option may include, for example, any of the following: delay handover (HO), early HO, split PDU set, and/or split PDU set after content ratio requirement met. The PDU set mobility option may have any of the following example granularities: per PDU session, per QoS flow, per service data flow (SDF), and/or per PDU set. The PDU set context information may include, for example, any of the following information: PDU set delay budget (PSDB) information, PDU set error rate (PSER) information, and/or content ratio information.

Example procedures for target RAN node handling of PDU sets during a handover are disclosed herein. In an example, a target RAN node may receive a handover request message from a source RAN node, and the handover request message may include PDU set context information. The target RAN node may determine whether to admit the WTRU. The target RAN node may base this decision on the received PDU session context information. The target RAN node may send a handover request acknowledge message to the source RAN node. The target RAN node may send a pending handover message to the UPF (e.g., in the user plane, or in the control plane via the AMF). The target RAN node may start PDU set monitoring for the PDU sets. Monitoring is initialized based on the received PDU session context information.

Based on the PDU set monitoring, the target RAN node may determine that a PDU set QoS requirement will not be met. The target RAN node may send a PDU Set status report to the source RAN node. The status report may include PDU Set Context Information. The target RAN node may initiate a path switch exchange. The target RAN node may send a WTRU Context Release message to the source RAN node. The PDU Set context information may include any one or more of the following example information: PSDB information, PSER information, and/or content ratio information.

In another example, the target RAN node may receive a handover request message from a source RAN node, which may include a primary QoS profile and/or a secondary QoS profile. The target RAN node may determine to admit the WTRU. The target RAN node may send a handover request acknowledge message to the source RAN node. The target RAN node may receive a relayed PDU from the source RAN node. Based on the PDU set information in the relayed PDU, the target RAN node may determine whether the PDU is part of a split PDU set. The target RAN node may determine which QoS profile to apply (primary QoS profile or secondary QoS profile) based on the determination of whether the PDU is a split PDU set or a complete PDU set. The target RAN node may apply PDU set monitoring if it is determined to apply the primary QoS profile. The target RAN node may initiate a path switch exchange. The target RAN node may send a WTRU Context Release message to the source RAN node. In an example, the secondary QoS profile may not include PDU set QoS parameters. Further, example procedures for UPF handling of PDU sets during a handover are disclosed herein.

A PDU Set may be one or more PDUs carrying the payload of one unit of information generated at the application level (e.g. frame(s) or video slice(s) for eXtended Reality (XR) services). All the PDUs of a PDU set may be transmitted within the same QoS Flow. A PDU Set may have any one or more of the following characteristics (e.g., that may be used in a 5G system): PDU set related information; and/or PDU Set QoS parameters. PDU set related information may include information tied to individual PDU sets. PDU set related information may be determined by the UPF (e.g., via implementation or information carried in the header of traffic arriving over an N6 interface). PDU set related information may include any one or more of the following example information: PDU set sequence number; end of a PDU set; PDU sequence number within a PDU set; PDU Set size; PDU set importance (e.g., a parameter used to identify the importance of a PDU Set within a QoS flow); end of a burst; burst size; and/or time to next burst. PDU Set related information may be sent by the UPF to the RAN node via a general packet radio service (GPRS) tunneling protocol user plane (GTP-U) header of a user plane packet.

PDU Set QoS parameters may be used by the RAN nodes to provide PDU set-based handling of user plane traffic. PDU Set QoS parameters may be part of a QoS profile that is provided to the RAN node. PDU Set QoS parameters may include any one or more of the following example information: PDU Set Error Rate (PSER); PDU Set Delay Budget (PSDB); PDU Set Integrated Indication (PSIHI) (e.g., an indication whether all PDUs of the PDU set are needed by the application); and/or content ratio.

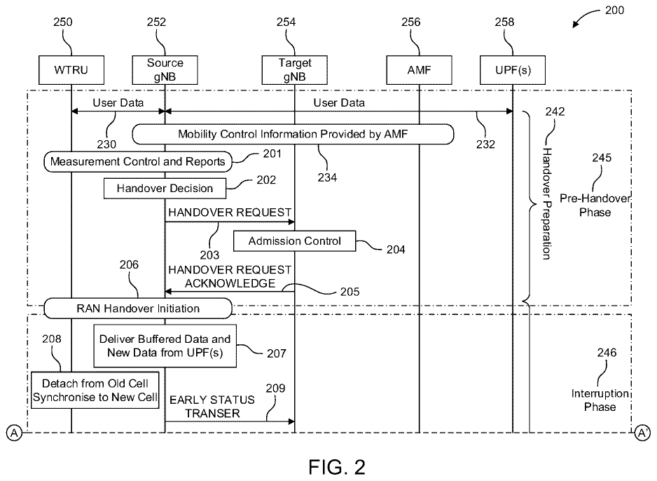

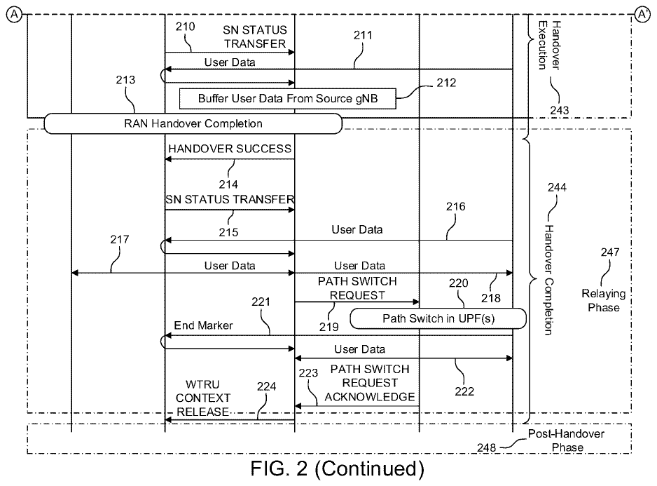

FIG. 2 is a flow diagram illustrating an example intra-system handover procedure 200 using an Xn interface. The intra-system handover procedure 200 includes the following phases: pre-handover phase 245 (including handover preparation steps 242), interruption phase 246 (including handover execution steps 243), relaying phase 247 (including handover completion steps 244), and post-handover phase 248. The communication system performing example intra-system handover procedure 200 includes at least WTRU 250, source gNB 252 (equivalently source base station or source RAN node), target gNB 254 (equivalently target base station or target RAN node), AMF 256 (e.g., residing on a network node), and UPF 258 (e.g., one or more UPFs residing on a network node). The following steps may occur during pre-handover phase 245. User data 230 received or transmitted by the WTRU 250 may be communicated between the WTRU 250 and the source gNB 252, and similarly user data 232 received or transmitted by the WTRU 250 may be communicated between the source gNB 252 and the UPF 258. At step 234, the AMF 256 may provide mobility control information to the source gNB 252 and/or the target gNB 254. At step 201, the WTRU 250, which may be “connected” to source gNB 252, may be configured to perform measurements and may transmit measurements (e.g., one or more measurement control and/or reports) to the source gNB 252.

At step 202, based on the measurements received from the WTRU 250, source gNB 252 decides that a handover is required. As part of handover preparation 242, the source gNB 252 may send a handover request message 203 to the target gNB 254 to check whether the target gNB 252 can accept the PDU sessions for the WTRU 250. At step 204, the target gNB 252 performs admission control to determine if it can accept the PDU sessions for the WTRU 250. The target gNB 252 may send a handover request acknowledge message to the source gNB 252 to indicate it can accept the PDU sessions for the WTRU 250. At step 206, the source gNB 252 may initiate the RAN handover (to target gNB 252), thus transition to interruption phase 243, which may include following steps.

At step 207, the source gNB 252 may deliver buffered data and data from UPF 258. At step 208, the WTRU may disconnect from the source gNB 252 and may start to synchronize with the target gNB 254. The source gNB 252 may send early status transfer message 209 to the target gNB 254. The source gNB 252 may send early sequence number (SN) status transfer message 210 to the target gNB 254.

There may be an interruption time, during which the WTRU 250 is not able to communicate (transmit or receive traffic) with the network. In this case, at step 211, downlink user data may be sent from UPF 258 to source gNB 252, which may relay the traffic (downlink user data) to target gNB 254. At step 212, the target gNB 254 may buffer the received downlink data until the WTRU 250 connects to the target gNB 254 (at this stage, the UPF 258 may not be aware that WTRU 250 is changing RAN nodes), thus transition to relaying phase 247, which may include following steps.

During relaying phase 247, at handover completion step 213, the network is trying to establish a new N3 path between the UPF 258 and the target gNB 254. The target gNB 254 may send handover success message 214 to the source gNB 252. The source gNB 252 may send SN status transfer message 215 to target gNB 254. At step 216, downlink user data continues to be sent from UPF 258 to source gNB 252, which relays the traffic to target gNB 254. Once the handover is complete, user data 217 received or transmitted by the WTRU 250 may be communicated between the WTRU 250 and the target gNB 254, and similarly user data 218 received or transmitted by the WTRU 250 may be communicated between the target gNB 254 and the UPF 258. The target gNB 254 may send a path switch request message 219 to the AMF 256, which may send path switch message 220 to the UPF 258. The UPF 258 may send an end marker message 221 to the source gNB 254, which may relay it to the target gNB 252 (and which may confirm receipt to the target gNB 254). User data 222 received or transmitted by the WTRU 250 may be communicated between the target gNB 254 and the UPF 258. The AMF 356 may send a path switch request acknowledge message 223 to the target gNB 254. The target gNB 254 may send to the source gNB 252 a WTRU release context message 224 for the WTRU 250. Subsequently, during the post-handover phase 248, the WTRU 250 is “connected” to the target gNB 254, the WTRU 250 may be configured for measurements (not shown), and downlink data (not shown) intended for the WTRU 250 may be sent from UPF 258 to target gNB 254 without relaying.

Example interruption times may be in the order of 50-90 msec, but this amount of time may be reduced to the order of 10-20 msec by using advanced techniques such as pre-synchronization. But even with pre-synchronization, the values may be considerable in consideration of a typical video frame being produced every 1/60=16.6 msec. In addition, it is important to note that the interruption time and relaying time may be longer for N2-based handovers.

In 3GPP Release 19, handover decisions may not be impacted by PDU sets. In this case, the PDUs of a single PDU set may be sent in any of the handover phases: pre-handover phase, interruption phase, relaying phase, and/or post-handover phase. As a result, based on the timing of the handover, some PDU sets of an SDF may be sent using a source RAN node, some PDU sets of the SDF may be sent using a target RAN node, and some PDU sets of the SDF may be split between the source RAN node and the target RAN node. Relying on this type of Release 19 handover procedure for WTRUs with PDU set-based traffic may be problematic. For example, the handover procedure may lead to some inefficiencies in PDU set handling (e.g., wasted over-the-air transmissions) and the handover procedure may result in inconsistent behavior at the RAN nodes (e.g., incorrect monitoring or not being able to monitor for PSDB and PSER requirements).

In an example scenario, the first PDU of a PDU set may start transmission during the pre-handover phase and later PDUs of the PDU set may be transmitted during a post-handover phase. In this case, some PDUs of a PDU set may be sent by the source RAN node, some PDUs of the PDU set may be relayed by the source RAN node to the target RAN node, and some PDUs of the PDU set may be sent by the target RAN node. To manage cases like this, solutions are disclosed herein to address how PDU set monitoring is managed. Additionally, for PSDB, solutions are disclosed herein to address how the delay budget of a PDU set is maintained. For PSER, solutions are disclosed herein to address how the PDU set transmission counts (successful and/or unsuccessful transmissions) are maintained. Solutions are disclosed herein to address how the error rate calculated. Solutions are disclosed herein to address how the source RAN node and target RAN node handle the content ratio. Solutions are disclosed herein to address optimizing relaying of PDU set traffic (during interruption phase and/or relaying phase) based on PDU set QoS requirements.

In another example scenario, the first PDU of a PDU set may start transmission during an interruption phase. In such a case, the UPF may have no idea that the WTRU is performing a handover, and that the WTRU will be unreachable during the interruption time. PDU sets arriving during this time may not meet the PSDB requirement. In such cases, the transmission of the PDU set may needlessly consume network resources and/or over-the-air resources. To manage cases like this, solutions are disclosed herein to address how the UPF can benefit from knowledge of the WTRU handover. Optimizing the mobility procedure to deal with PDU sets may result in another problem. For example, there are multiple PDU set mobility options to address mobility for WTRUs with PDU set based traffic. The network needs to select the best PDU set mobility option to apply. To manage this issue, solutions are disclosed herein for the network to decide on the best PDU set mobility option to use. Additionally, solutions are disclosed herein to determine what assistance information is needed to help make the decision on the best PDU set mobility option to use. Additionally, solutions are disclosed herein to determine what granularity to use to help make the decision on the best PDU set mobility option to use. Solutions are disclosed herein to determine if the selected PDU set mobility option apply to the entire PDU session, to a QoS flow, to an SDF, and/or to a PDU set.

Herein, the term “Information Element (IE)” may be used to refer to one or more information that are grouped together. An IE may be made up of one or more other IEs. Herein, the term “split PDU set” is used to denote a PDU set whose PDUs are transmitted via two different RAN nodes. For example, a partial set of PDUs of the PDU set sent over a source RAN node and the remaining PDUs of the PDU set sent over a target RAN node. Herein, the term “Indication that the PDU set should not be split” refers to an explicit indication or an implicit indication. Upon receiving an implicit indication, the network determines that the PDU sets should not be split and that the network should try to send the PDUs of the PDU sets over the same RAN node. Examples of implicit indications that a PDU set should not be split include: having a service data flow that is very sensitive to delay or loss and that has very stringent requirements for loss and/or delay; having a service data flow that is very sensitive to differentiated treatment; having a PDU set with a high priority, for example based on the PDU set importance; and/or having a QoS flow with a high priority.

Herein, the term “PDU Set Mobility option” may be used to refer the method used/enforced at the RAN nodes to manage mobility and handover for WTRU traffic that may be PDU set based. Herein, the term “determination of PDU Set mobility option” may be used to refer to one of the mechanisms used by the network and/or RAN node, to determine the PDU set mobility option to use. Herein, the term “content ratio requirement” is used to refer to the PDU set QoS requirement related to content ratio. The requirement is deemed to be met, if the number of successfully transmitted PDUs is higher than the content ratio. Herein, the term “triggering a handover” may be used to refer to the trigger at a RAN node that leads to the WTRU disconnecting from the source RAN node. Herein, the term “handover phase” or “phase of the handover procedure” may be used interchangeably. These for example may denote one of the phases described in FIG. 2 (pre-handover, interruption, relaying, post-handover). Herein, the term “PDU set monitoring” is used to denote the actions taken at a RAN node related to the monitoring of PSDB, PSER, PSIHI, content ratio, etc. For example, for PSDB the PDU set monitoring may refer to how the RAN node determines the time that remains in the delay budget for this PDU set. As another example, for content ratio the PDU set monitoring may refer to how the RAN node determines if enough PDUs of the PDU set have been successfully transmitted to a WTRU. As another example, for PSIHI, the PDU set monitoring refers to how he RAN node determines an integrated handling error. Herein, the term “gNB”, “RAN node” and base station are used interchangeably.

As discussed hereinbefore, a handover may be include the following phases: pre-handover, interruption, relaying, and post-handover. To address how the PDU set should be handled during a handover, procedures are disclosed herein to determine the PDU set handling method to apply (or enforce) for a PDU set, and the assistance information that may be used to make this determination. Additionally, procedures are disclosed herein to perform PDU set monitoring for PDU sets that are split between source RAN node and a target RAN node. Additionally, procedures are disclosed herein performed by a UPF upon receiving an indication that a WTRU is unreachable as a result of a handover. Additionally, procedures are disclosed herein to determine which PDUs of a PDU set need to be relayed from a source RAN node to a target RAN node during the handover procedure.

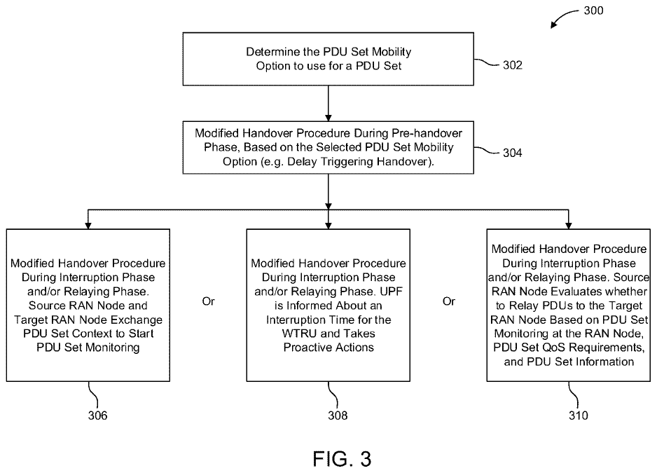

FIG. 3 is a flow diagram illustrating an example procedure 300 for handling PDU sets during the phases (pre-handover, interruption, relaying, and post-handover) of a handover procedure. At step 302, a network entity (e.g. AMF, source RAN node) may determine the PDU set mobility option to use for a PDU set. At step 304, the source RAN node may perform a modified handover procedure during pre-handover phase, based on the selected PDU set mobility option. For example, this may involve delaying the triggering of the handover to avoid splitting a PDU set. Three example modified handover procedures 306, 308, and 310 are shown as possible alternative steps following step 304. According to step 306, network entities (e.g. source RAN node, target RAN node) may perform a modified handover procedure during an interruption phase and/or relaying phase. When a source RAN node triggers a handover to a target RAN node, the source RAN node may provide PDU set context info to the target RAN node. The target RAN node may use this information to start PDU set monitoring.

Alternatively, at step 308, network entities (e.g. source RAN node, target RAN node, AMF, UPF) may perform a modified handover procedure during the interruption phase and/or relaying phase. The UPF may informed about an interruption time for the WTRU and may take proactive actions. Alternatively, at step 310, source RAN node may perform a modified handover procedure during the interruption phase and/or relaying phase. Source RAN node may evaluate whether to relay PDUs to the target RAN node based on PDU set monitoring at the RAN node, PDU Set QoS requirements, and PDU set information.

Regarding PDU set context, the source RAN node may already provide the PDU set QoS parameters to the target RAN node during the handover request exchange. Similarly, during the interruption phase and relaying phase, the PDU set information related to a PDU set may be provided from the source RAN node to the target RAN node via the GTP-U header of the user plane PDUs that are forwarded/relayed by the source RAN node. The PDU Set Context may refer to additional information related to PDU sets, that is known to one RAN node, and that may need to be provided to another RAN node or another network entity, for example the UPF.

The PDU Set Context may include any one or more of the following: Partial PDU set flag; PSER context; and/or list of active PDU sets. Partial PDU set flag may be an indication that some PDU sets of the QoS flow may be split PDU sets. This flag does not identify the specific PDU set. PSER context may refer to context related to the PSER that is maintained by a RAN node. For example, this may be the number of correctly received PDU sets for a QoS flow or incorrectly received PDU sets for a QoS flow. Alternatively, this may be an indication that the PSER requirement for a QoS flow has not been met. List of active PDU sets may refer to a list of PDU sets that are actively being transmitted by the source RAN node, and will likely be split. Each PDU set may be identified by a PDU Set identifier. For example, this may be the PDU Set Sequence number.

For each PDU set in the List of active PDU sets, the PDU Set context may additionally include: split PDU set flag; PSDB context; content ratio context; PSIHI context; PDU sequence number within a PDU set; PDU set size; and/or PDU set importance. Split PDU set flag may be an indication that the PDU set is a split PDU set. That is, some PDUs of the PDU set have already been transmitted by the source RAN node, and the remaining PDUs of the PDU set will be sent via a target RAN node. PSDB context may refer to context related to the PSDB that is maintained by a RAN node. For example, this may be the starting time of a PDU set, or time remaining in PSDB for the PDU set. Alternatively, this may be an indication that the PSDB requirement for a PDU set has not been met. Content ratio context may refer to context related to the content ratio that is maintained by a RAN node for a PDU set. For example, this may be the number (or a count) of PDUs of a PDU set that are successfully transmitted by the RAN node, or that are unsuccessfully transmitted by the RAN node. Alternatively, this may be a percentage (or a ratio) of PDUs of a PDU set that are successfully transmitted by the RAN node, or that are unsuccessfully transmitted by the RAN node. Alternatively, this may be an indication that the content ratio requirement for a PDU set has not been met. PSIHI context may refer to context related to the integrated handling that is maintained by a RAN node for a PDU set. For example, this may be an indication that all PDUs of a PDU set that have been transmitted (say K PDUs out of N total PDUs of PDU set, where N>K) by the RAN node, have been successfully transmitted. Alternatively, this may be an indication that the integrity handling requirements for a PDU set have not been met.

PDU sequence number (SN) within a PDU Set may identify the last PDU of the PDU set identified by the PDU set identifier, that was transmitted over the source RAN node. PDU set size may reflect the total size of the PDU set. The number may be based on the PDU Set Size of the last PDU of the PDU set identified by the PDU set identifier, that was transmitted over the source RAN node. PDU set importance may reflect the importance of the PDU set. Its value may be based on the PDU Set Importance of the last PDU of the PDU set identified by the PDU set identifier, that was transmitted over the source RAN node. The PDU Set context may be exchanged between RAN nodes via a PDU Set Context IE. PDU Set context may be exchanged between the source RAN node and the target RAN node.

Regarding PDU set mobility options, when a WTRU is transmitting or receiving XRM traffic via PDU sets, there may be a number of options to deal with handovers during PDU set transmission. In an example PDU Set mobility option (“first PDU Set mobility option”), the network may decide to do nothing (i.e. operate according to Release 19) and may trigger a handover independently of PDU set transmission. This may result in splitting a PDU set across two RAN nodes. Splitting some PDU sets may lead to some performance inefficiency. In another example PDU Set mobility option (“second PDU Set mobility option”), the network may decide to trigger early handovers so as not to not split a PDU set across a source RAN node and target RAN node. The network may determine that a handover is imminent, and it may trigger an early handover for the WTRU, before the start of a PDU set.

In another example PDU Set mobility option (“third PDU Set mobility option”), the network may decide to delay handovers so as not to not split a PDU set across a source RAN node and target RAN node. The network may determine that a handover is imminent, and it may delay triggering the handover of the WTRU until the PDU set has been transmitted. In another example PDU Set mobility option (“fourth PDU Set mobility option”), the network may decide to trigger handovers without regard to whether a PDU set is split and then manage the impact of splitting the PDU set across a source RAN node and target RAN node. In another example PDU Set mobility option (“fifth PDU Set mobility option”), the network may decide to trigger handovers without regard to whether a PDU set is split but provide a differentiated service to the split PDU sets.

In another example PDU set mobility option (“sixth PDU Set mobility option”), the network may decide to trigger handovers and split a PDU set, but the decision is based on some PDU set QoS requirement and/or PDU set information. In an example, the network may trigger a handover and split a PDU set, if the content ratio requirement is met in a source RAN node. That is, enough PDUs of the PDU set have been successfully transmitted in the source RAN node to meet the content ratio requirement. In another example, the network may trigger a handover and split a PDU set, if the PSDB associated with the PDU set is already exceeded over the source RAN node. In another example, the network may trigger a handover and split a PDU set, if the PDU set requires integrated handling (PSIHI is set), but at least one of the PDUs of the PDU set is not successfully transmitted over the source RAN node. In another example, the network may trigger a handover and split a PDU set, based on the PDU set priority (e.g. PSI above a threshold, where higher PSI indicates a lower priority). In another example, the network may trigger a handover and split a PDU set, based on the PDU set size (e.g. PDU set size above a threshold).

Regarding determination of the PDU set mobility option, the network may decide which PDU Set mobility option to use to deal with handovers during PDU set transmission. The granularity of the PDU set mobility option may be, for example, any of per WTRU, per PDU session, per QoS flow, per SDF, per multiplexed stream of an SDF, or per PDU set. For example, some WTRUs may be configured to always use the first PDU set mobility option, while other WTRUs may have a PDU set mobility option determined per PDU set. The network may make this decision based on one or a combination of the following determination options. In an example determination of PDU Set mobility option, the network may be pre-configured with a PDU Set mobility option. In another example determination of PDU Set mobility option, the application function (AF) may provide a preference to the network with regards to the handling of PDU sets. For example, the AF may indicate that the PDU sets should not be split or that the PDU set may be split but that the decision should be based on some PDU set QoS requirement. The preference provided by the AF may be per SDF or per multiplexed stream within the SDF. The preference may be provided to the network using the Nnef_AFsessionWithQoS service.

In another example determination of PDU set mobility option, the WTRU may provide a preference to the network with regards to the handling of PDU sets. For example, the WTRU may indicate that the PDU sets should not be split or that the PDU set may be split but that the decision should be based on some PDU set QoS requirement. The preference provided by the WTRU may be, for example, per PDU session, per QoS flow, per SDF, or per multiplexed stream within the SDF. The indication may be provided to the network during a PDU session establishment/modification exchange. In another example determination of PDU Set mobility option, the UPF may provide a preference to the RAN node with regards to how the RAN node should handle the PDU set. For example, the UPF may indicate that PDU sets should not be split. The UPF may provide this indication to the RAN node along with other PDU set information, in the GTP-U header. The indication may be different for each PDU set. The UPF may make this determination based on header information of the PDU received over the N6 interface from the Application Server (AS). For example, the real time transport (RTP) header of a PDU received over the N6 interface, may carry an explicit or implicit indication about PDU Set splitting.

Example modified handover procedures to handle PDU sets are disclosed herein. A 3GPP Release 19 handover procedure may be modified to efficiently handle PDU sets. Several example modifications are proposed herein, which may be used separately or in any combination. The modifications may depend on the selected PDU set mobility option and the phase of the handover procedure.

Example modified handover procedures may be used for example during the pre-handover phase. An example modification may apply to the case where the network selects to use the second PDU set mobility option. That is, a PDU set is not split and triggering a handover is delayed until the complete PDU set is transmitted. Based on this determination, the source RAN node may be triggered to modify the WTRU measurement configuration to provide an early indication of a potential handover condition. This may be useful as the source RAN node may want to know very early about potential imminent handovers, so that it may prioritize the transmission of all PDUs of a PDU set that should not be split. As a result, the source RAN node modifies the measurement configuration so that the WTRUs report potential issues earlier. The source RAN node may then trigger a handover after all PDUs of the PDU set are transmitted. The source RAN node may be configured with a maximum delay, after which the handover is triggered, irrespective if all PDUs of the PDU set are transmitted. Alternatively, the source RAN node may receive another measurement report from the WTRU, indicating a further deterioration. This too may trigger an immediate handover decision from the source RAN node. As an alternative, the source RAN node may prioritize transmission of existing PDU sets during the pre-handover phase, and it may delay transmission of any new PDU sets to the post-handover phase. For example, by buffering downlink PDUs at the UPF and by buffering uplink PDUs at the WTRU.

An example modification may apply to the case that the network selects to use the third PDU set mobility option. That is, a PDU set is not split and trigger an early handover, where the source RAN node waits for a period of time where there is no ongoing PDU set transmission, and triggers the early handover during this period. Based on this determination, the source RAN node may be triggered to modify the WTRU measurement configuration to provide an early indication of a potential handover condition. This may be useful as the source RAN node may want to know very early about potential imminent handovers, so that when it has no ongoing PDU set transmissions, it may trigger an early handover. If necessary, any new PDU sets may be buffered until the post-handover phase.

Another example modification may apply to the case that the network selects to use a combination of the second and third PDU set mobility options. That is, not split a PDU set and trigger an early handover or a late handover, depending on whether some PDUs of a PDU set have already been transmitted by the source RAN node. This case may apply when an early handover is enabled, and handover is imminent, but there is an ongoing PDU set transmission. For example, the potential imminent handover notification and the initial PDUs of a non-split PDU Set have been received at the RAN node. If no PDUs of the PDU set have been sent to WTRU, the source RAN node may decide to buffer the PDUs of the PDU set and trigger an early handover. If some PDUs of the PDU set have already been sent by the source RAN node, then the source RAN node may decide to send the rest of the PDUs of the same PDU set, and then perform a late handover.

Example modified handover procedures may be used for example during the interruption phase and/or relaying phase. Another example modification may apply to the case that the network selects to use the second PDU set mobility option or the third PDU set mobility option (i.e., not split a PDU set). If a first PDU of a PDU set arrives during the interruption phase or relay phase, this PDU and all other PDUs of the PDU set are buffered until the post-handover phase. The buffering may be done at the PDU session anchor (PSA) UPF for downlink traffic and at the WTRU for uplink traffic. This may guarantee that the PDUs of the PDU set are not transmitted across multiple RAN nodes.

Example modified handover procedures may be used for example during the interruption phase. When a handover is triggered, the RAN node (source RAN node or target RAN node) may send a PENDING HANDOVER indication to the UPF. The request may indicate to the UPF that the WTRU is undergoing a handover and will not be reachable for some interruption time. The indication may be sent in a header of user plane traffic from the RAN node to the UPF. Alternatively, the indication may be sent in a control plane message to the AMF, which may then forward the indication to the UPF. The RAN node may additionally provide an identifier of the WTRU. The RAN node may additionally provide an indication of the duration of the interruption time. The UPF may use this indication to perform one or more of the following: buffer PDUs of a PDU set that should not be split, at least until the path switch procedure to the target RAN node is complete; based on the duration of the interruption time (e.g., provided by the RAN node, determined through analytics from the NWDAF, and/or pre-configured in the network), the UPF may decide to discard PDUs and PDU sets that will not meet the PSDB requirements; and/or inform the application server (AS)/AF that the WTRU will be unreachable during the interruption time.

Another example modification may apply to the case that the network selects to use a PDU set mobility option where the PDU set may be split across source RAN node and target RAN node (e.g., the fourth, fifth, or sixth PDU set mobility options described herein). The modification may apply to the pre-handover phase, for example with respect to the preparation of the target RAN node. In an example, the source RAN node may include the PDU set context IE within the HANDOVER REQUEST message to the target RAN node. This PDU set context IE may be used by the target RAN node for one or more of the following: admission control; initializing PDU set monitoring for the ongoing PDU sets; and/or disabling PDU set monitoring.

For admission control, the target RAN node may use the information to determine whether to admit the WTRU and to determine which PDU sessions to accept. For example, the PDU set context IE may indicate that a number of PDU sets are ongoing and are of high priority. These PDU sets may further be very large, and the target RAN node may decide that the interruption time may be too large for these PDU sets. Consequently, the target RAN node may decide to refuse the handover request.

For initializing a PDU set monitoring for the ongoing PDU sets, the PDU sets that are split between the source RAN node and the target RAN node may need to transfer their PDU set monitoring from the source RAN node to the target RAN node. For PSDB, the target RAN node may use the received PSDB context to initialize the time left in the delay budget for each split PDU set. For content ratio, the target RAN node may use the content ratio context to initialize the counters for calculating the content ratio for each split PDU set. For PSER, the target RAN node may use the PSER context to initialize the count of the number of unsuccessful PDU set transmissions for each QoS flow. For PSIHI, the target RAN node may use the PSIHI context to set the indication of a dropped PDU for this PDU set.

For disabling PDU set monitoring, in some cases, the target RAN node may use the PDU set context IE to stop PDU set monitoring. For example, if the PSDB context already indicates that the delay budget has been exceeded, the target RAN node may refrain from monitoring the PSDB for this PDU set. Similarly, if the content ratio context indicates that the content ratio requirement has already been met for this PDU set, the target RAN node may refrain from monitoring the number of successful PDU set transmissions.

Another example modification may apply to the case that the network selects to use a PDU set mobility option where the PDU set may be split across source RAN node and target RAN node (e.g., the fourth, fifth, or sixth PDU set mobility options described herein). This example modification applies to the interruption phase and/or the relaying phase. During these phases, the source RAN node needs to relay DL PDUs to the target RAN node, while waiting for the path switch to the target RAN node. Based on the Release 19 handover procedure, the source RAN node forwards all PDUs to the target RAN node, for those PDU sessions that have been accepted by the target RAN node. In cases where these relayed PDUs are part of a PDU set, the source RAN node may use some relaying decision logic to determine whether or not to relay a PDU of a PDU set. The source RAN node may base the relaying decision based on the PDU session context at the source RAN node.

In an example, the source RAN node may evaluate if the PSIHI context indicates that the PDU set already has a PDU that was not successfully transmitted. In this case, there may be no advantage to relay the remaining PDUs of the PDU set to the target RAN node, and the source RAN node may discard these PDUs. In another example, the source RAN node may evaluate if the PSDB context indicates that the delay budget for this PDU set has already been exceeded. In this case, there may be no advantage to relay the remaining PDUs of the PDU set to the target RAN node, and the source RAN node may discard these PDUs. In another example, the source RAN node may evaluate if the content ratio context indicates that the content ratio requirement has already been met. In this case, the WTRU does not need the remaining PDUs to recover the entire PDU set, and there may be no advantage to relay the remaining PDUs of the PDU set to the target RAN node. The source RAN node may discard these PDUs. The relaying decision may additionally be affected by the duration of the interruption time and/or the relaying time.

Another example modification may apply to the case that the network selects to use a PDU set mobility option where the PDU set may be split across source RAN node and target RAN node (e.g., the fourth, fifth, or sixth PDU set mobility options described herein). This example modification may apply to the interruption phase and/or the relaying phase. During these phases, the source RAN node needs to relay DL PDUs to the target RAN node, while waiting for the path switch to the target RAN node. The SMF and the UPF may be unaware that the WTRU is communicating over the target RAN node, and they may assume that all PDU set monitoring is being performed at the source RAN node. In some cases, the SMF and/or UPF may need to be made aware of the state of PDU set monitoring (for example whether a PSDB has been exceeded for a PDU set, whether the PSER has been exceeded for a QoS flow, whether all PDUs of a PDU set have been delivered, etc.). If there is a change in the state of the PDU set monitoring, the target RAN node may send a PDU SET CONTENT UPDATE message to the source RAN node. The PDU SET CONTENT UPDATE message may contain a PDU Set Context IE.

Another example modification may apply to the case that the network selects to use a PDU set mobility option where the PDU set may be split across source RAN node and target RAN node (e.g., the fourth, fifth, or sixth PDU set mobility options described herein). This example modification may apply to the source RAN node. The source RAN node may stop PDU set monitoring for all split PDU sets.

Another example modification may apply to the case that the network selects to use a PDU set mobility option where the PDU set may be split across source RAN node and target RAN node (e.g., example, the fourth, fifth, or sixth PDU set mobility options). This example modification may apply to the target RAN node. The target RAN node may stop PDU set monitoring for all split PDU sets. Alternatively, the target RAN node may use the information in the PDU set context IE to infer how to perform PDU set monitoring. If a count/ratio is provided to the target RAN node in the PDU set context IE, the target RAN node may use this in its heuristics to determine how to enable the PDU set monitoring. In an example, if the ratio of successfully transmitted PDUs provided in the PDU set context IE is one third (⅓), the target RAN node may determine to leave only two thirds (⅔) of configured PDU set delay budget. For example, if a count of successfully transmitted PDUs is provided in the PDU set context IE, the target RAN node may consider that this count has been delivered successfully, and take this into account for its PDU set monitoring.

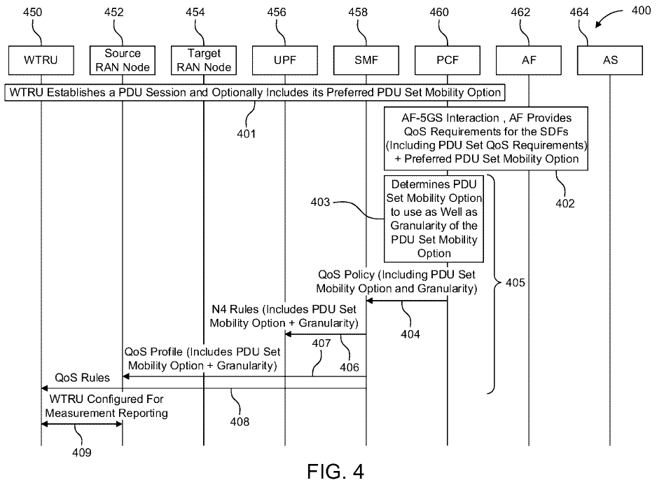

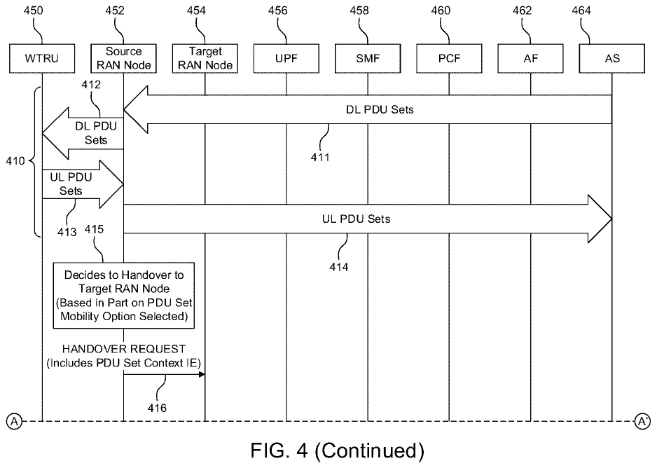

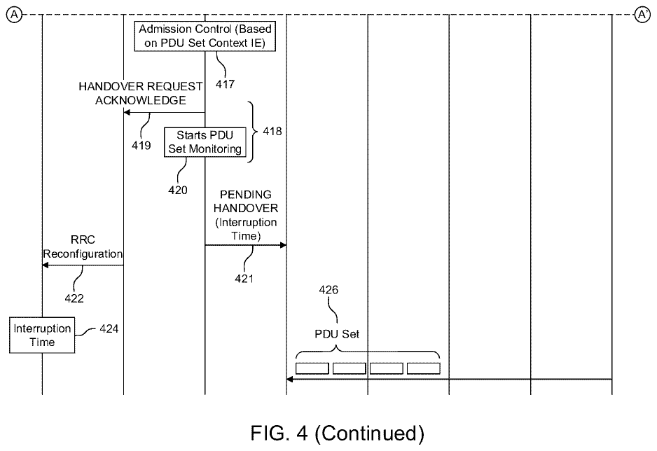

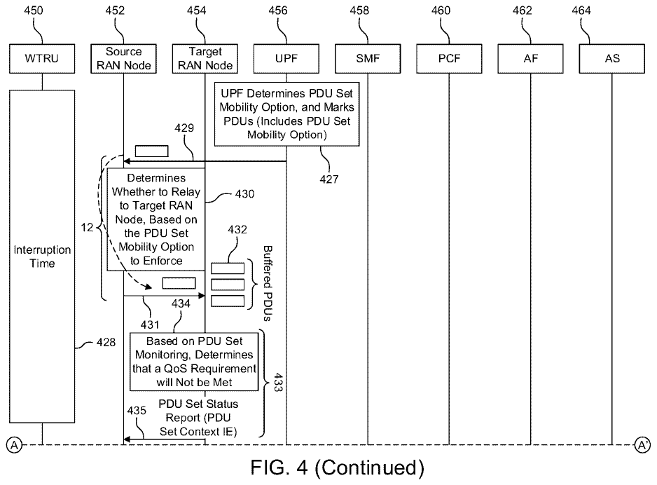

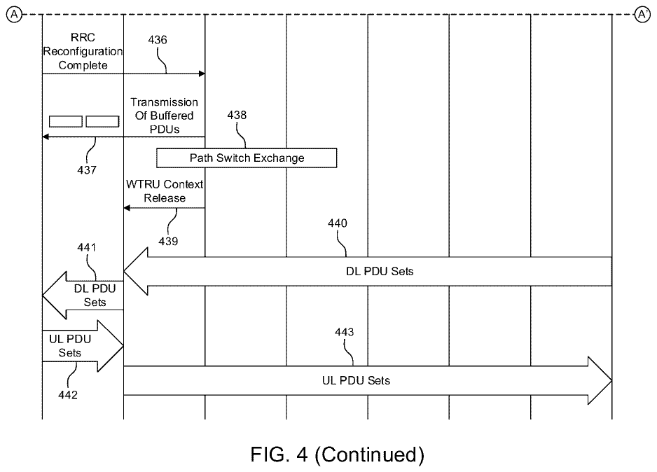

An example procedure for mobility handling for user data (traffic) with PDU sets is disclosed herein in. FIG. 4 is a flow diagram illustrating an example mobility handling procedure 400 for user data with PDU sets. The communication system performing example mobility handling procedure 400 includes at least WTRU 450, source RAN node 452 (equivalently source base station or gNB), target RAN node 454 (equivalently target base station or target gNB), UPF 456, SMF 458, PCF 460, AF 462, and AS 464. Each of UPF 456, SMF 458, PCF 460, AF 462, and AS 464 may reside on one or more network nodes, and some subsets of UPF 456, SMF 458, PCF 460, AF 462, and AS 464 may be co-located on a common network node.

In step 401, the WTRU 450 may establish a PDU session for the XRM traffic. As part of the PDU session establishment, the WTRU 450 may provide an indication of its preferred PDU set mobility option. The network (e.g., SMF 458) may provide the QoS rules to the WTRU 450, the QoS profile to the source RAN node 452, and the N4 rules to the selected PSA UPF 456. The QoS profile may include PDU set QoS requirements.

In step 402, the AF 462 may configure the network with QoS related information for the XRM traffic. The configuration may include the preferred PDU set mobility option for an SDF or for a multiplexed stream within an SDF.

Step 405 may include steps 403, 404, 406, 407 and 408. As part of step 405, in step 403, the network (e.g., the SMF 458 and/or PCF 460) may determine the PDU set mobility option to use, as well as the granularity of the PDU set mobility option. Granularity may refer to whether the option applies to the entire PDU session, one or more QoS flows of the PDU session, one or more SDFs, or one or more multiplexed streams within SDF. The network may base the decision on the preference of the WTRU 450, the preference of the AF 462 and/or AS 464, and/or network (pre-)configuration. The PCF 460 may use a PDU Session modification procedure to trigger (e.g., by sending QoS policy 404 to the SMF 458) the SMF 458 to send modified QoS rules 408 to the WTRU 450, and send a modified QoS profile 407 to the source RAN node 452, and send modified N4 rules 406 to the PDU Session Anchor (PSA) UPF 456. The modified N4 rules 406 and modified QoS profile 407 may be enhanced to indicate the PDU set mobility option to use, as well as the granularity of the PDU set mobility option (e.g., if the option applies to the entire PDU session, one or more QoS flows of the PDU session, one or more SDFs, or one or more multiplexed streams within SDF).

In step 409, the source RAN node 452 may configure the WTRU 450 measurement procedures and the WTRU 450 may report measurements to the source RAN node 452 according to the measurement configuration.

Step 410 may include steps 411, 412, 413 and 415. In step 410, the WTRU 450 sends and receives XRM traffic to and from the source RAN node 452 (i.e., receives DL PDU sets 412 from the source RAN node 452, which were forwarded as DL PDU sets 411 from the AS 464, and transmits UL PDU sets 413 to the source RAN node 452, which get forwarded as UL PDU sets 414 to the AS 464). The XRM traffic is made up of PDU sets, and the UPF 456 may add PDU set information to all downlink PDUs 411 sent to the source RAN node 452. The source RAN node 452 may perform PDU set QoS handling.

In step 415, based on at least one of the received measurement reports, the RRM information, and/or the selected PDU set mobility option, the source RAN node 452 may trigger a handover for the WTRU 450. The source RAN node 452 may select the target RAN node 454 based on the information contained in the measurement report. The source RAN node 452 may transmit a HANDOVER REQUEST message 416 to the selected target RAN node 454, which may include information (e.g., in a transparent RRC container) to prepare the handover at the target RAN node 454. The information may include the PDU session related information that includes QoS flow level QoS profile(s), as well as a PDU Set Context IE.

In step 417, admission control may be performed by the target RAN node 454. In an example not shown, the target RAN node 454 may reject the HANDOVER REQUEST 416 based on the PDU Set Context IE.

In step 418, the target RAN node prepares the handover and may send the HANDOVER REQUEST ACKNOWLEDGE 419 to the source RAN node 452, which may include information (e.g., in a transparent container) to be sent to the WTRU 450 as an RRC message to perform the handover. Step 418 further includes the target RAN node 454 additionally starting PDU set monitoring 420 for the split PDU sets, based on the received PDU Set Context IE.

The target RAN node 454 may send a PENDING HANDOVER indication 421 to the PSA UPF 456 (PENDING HANDOVER indication 421 may first be sent to an AMF, not shown, which may forward it to UPF 456). In response, the PSA UPF may inform the AS 464 about the interruption time 424 impacting the WTRU 450 connectivity via a message (not shown) which may include an indication of the interruption time.

The source RAN node 452 may trigger the handover by sending an RRCReconfiguration message 422 to the WTRU 450, containing the information required to access the target RAN node 454. The WTRU 450 may disconnect with the source RAN node 452 and may attempt to synchronize to the target RAN node 454. During interruption time 424, a downlink PDU set 426 may arrive at the UPF 456 from the AS 464. At step 427, the UPF 456 may mark the DL traffic 426 with PDU set information and send the marked PDUs of the PDU set 429 to the source RAN node 452. The PDU set information may be enhanced to include PDU set mobility option information (e.g., an indication to use a specific PDU set mobility option). The UPF 456 may make this determination based on the N4 rules received in step 406, or based on information in the header of the PDUs received over the N6 interface.

In step 430, the source RAN node 452 may enforce the PDU set mobility option to use for this PDU set. The PDU set mobility option to enforce may be based on the PDU set information carried in the GTP-U header from the UPF 456, may be based on information contained in the QoS profile provided to the source RAN node 452, or may be (pre)-configured in the network. In this example, the PDU set mobility option used is where the PDU set may be split across source RAN node 452 and target RAN node 454. For example, the fourth, fifth, or sixth PDU set mobility options as described herein. For each PDU of a PDU set, the source RAN node 452 evaluates if the PDU 431 should be relayed to the selected target RAN node 454. The evaluation may be based on the PDU set monitoring over the source RAN node 452, the PDU set QoS parameters, and/or the PDU set information. For example, if the PSDB for the PDU set is already exceeded, the source RAN node 452 may decide to not relay a PDU. At step 432, PDUs from the PDU set sent to the target RAN node 454 may be buffered at the target RAN node 454.

Step 433 may include steps 434 and 435. In step 433, the PDU set mobility option where the PDU set may be split across source RAN node 452 and target RAN node 454 may be enforced. For example, the fourth, fifth, or sixth PDU set mobility options as disclosed herein. At step 434, based on the PDU set monitoring at the target RAN node 454, the target RAN node 454 may determine that a PDU set QoS requirement will not be met. The target RAN node 454 may then send a PDU set status report 435 to the source RAN node 452, to notify the source RAN node 452 about the failure. The PDU set status report 435 message may include PDU Set Context IE.

The WTRU 450 may connect to the target RAN node 454 and complete the handover procedure by sending RRCReconfigurationComplete message 436 to target RAN node 454. The target RAN node may send relayed PDUs 437 to the WTRU 450. A path switch exchange 438 occurs, where the target RAN node 454 may send a PATH SWITCH REQUEST message to the AMF (not shown), which may trigger the user plane path to switch from the UPF 456 connection to the source RAN node 452 to a UPF 456 connection to the target RAN node 454. As part of path switch exchange 438, the target RAN node 454 may receive a PATH SWITCH REQUEST ACKNOWLEDGE. The target RAN node 454 may send a request to the source RAN node 452 to release all context related to the WTRU 450 (e.g., WTRU CONTEXT RELEASE message 439). Subsequently, the WTRU 450 communicates over target RAN node 454, such that DL PDU sets 440 from AS 464 flow through target RAN node 454, and are forwarded as DL PDU sets 441 to WTRU 450. Similarly, UL PDU sets 442 are sent to target RAN node 454, which forwards as UL PDU sets 443 to AS 464. In an example not shown, the PDU set mobility option to use may also be determined in step 401, and the QoS rules to the WTRU 450, the QoS profile to the source RAN node 452, and the N4 rules to the selected PSA UPF 456 may be may be enhanced to indicate the PDU set mobility option to use, as well as the granularity of the PDU set mobility option.

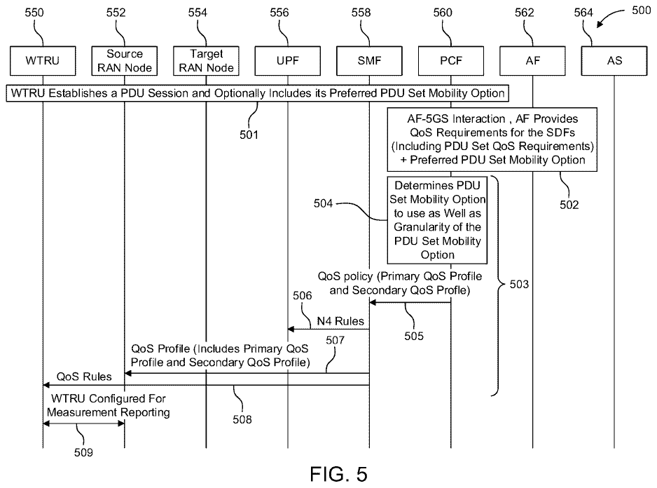

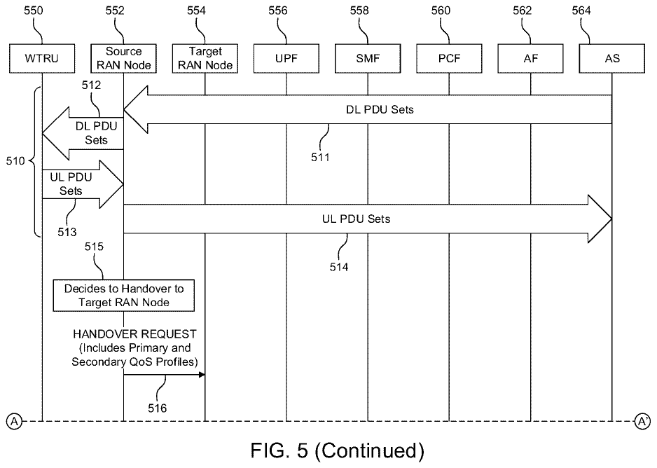

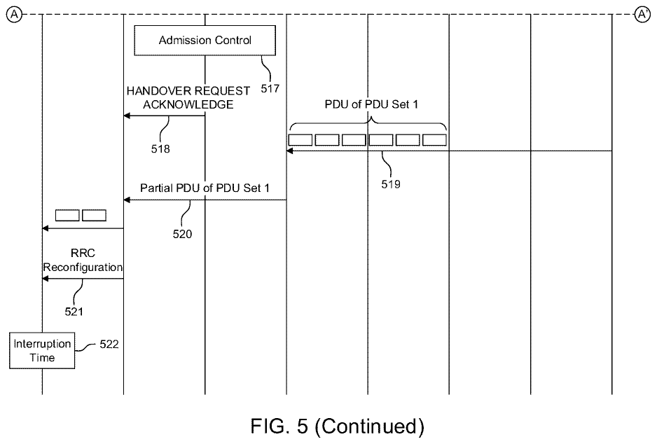

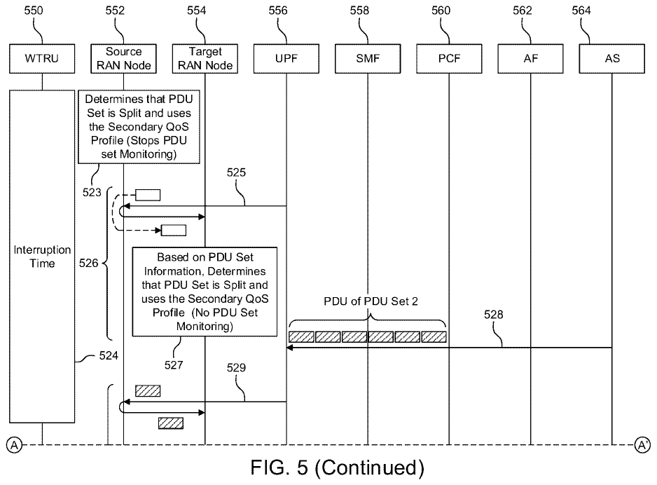

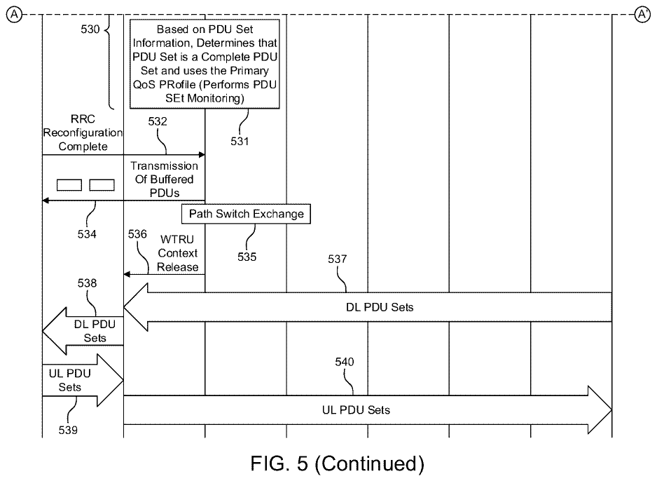

FIG. 5 is a flow diagram illustrating another example mobility handling procedure 500 for user data with PDU sets. The communication system performing example mobility handling procedure 500 includes at least WTRU 550, source RAN node 552 (equivalently source base station or source gNB), target RAN node 554 (equivalently target base station or target gNB), UPF 556, SMF 558, PCF 560, AF 562, and AS 564. Each of UPF 556, SMF 558, PCF 560, AF 562, and AS 564 may reside on one or more network nodes, and some subsets of UPF 556, SMF 558, PCF 560, AF 562, and AS 564 may be co-located on a common network node.

In step 501, the WTRU 550 may establish a PDU session for the XRM traffic. As part of the PDU session establishment, the WTRU 550 may provide an indication of its preferred PDU set mobility option. The network (e.g., SMF 558) may provide the QoS rules to the WTRU 550, the QoS profile to the source RAN node 552, and the N4 rules to the selected PSA UPF 556. The QoS profile may include PDU set QoS requirements.

In step 502, the AF 562 may configure the network with QoS related information for the XRM traffic. The configuration may include the preferred PDU set mobility option.

Step 505 may include steps 503, 504, 506, 507 and 508. As part of step 505, in step 503, based on the AF/AS preference, and/or WTRU preference, and or network (pre-)configuration, the network (e.g., the SMF 558 and/or PCF 560) may determine to use the fifth PDU set mobility option as described herein. The PCF 560 may use a PDU Session modification procedure to trigger (e.g., by sending QoS policy 504 to the SMF 558) the SMF 558 to send QoS rules 508 to the WTRU 550, and send modified QoS profile 507 to the source RAN node 552, and send N4 rules 506 to the PSA UPF 556.The QoS profile 507 may include PDU set QoS requirements in a primary QoS profile. The QoS profile 507 may additionally include a secondary QoS profile. The secondary QoS profile may not have any PDU set QoS parameters and applies to any PDU set that is split. In step 509, the source RAN node 552 may configure the WTRU 550 measurement procedures and the WTRU 550 may report measurements to the source RAN node 552 according to the measurement configuration.

Step 510 may include steps 511, 512, 513 and 515. In step 510, the WTRU 550 sends and receives XRM traffic to and from the source RAN node 552 (i.e., receives DL PDU sets 512 from the source RAN node 552, which were forwarded as DL PDU sets 511 from the AS 564, and transmits UL PDU sets 513 to the source RAN node 552, which get forwarded as UL PDU sets 514 to the AS 564). The XRM traffic is made up of PDU sets, and the UPF 556 may add PDU set information to all downlink PDUs 511 sent to the source RAN node 552. The source RAN node 552 may use the primary QoS profile and perform PDU set QoS handling and PDU set monitoring.

In step 415, based on at lest one of the received measurement reports and RRM information, the source RAN node 552 may determine that a handover is required for the WTRU 515. The source RAN node 552 may select the target RAN node 554 based on the information contained in the measurement report. The source RAN node 552 may transmit a HANDOVER REQUEST message 516 to the selected target RAN node 554, which may include information (e.g., in a transparent RRC container) to prepare the handover at the target RAN node 554. The information may include the PDU session related information that includes QoS flow level QoS profile(s), which may include the primary QoS profile and the secondary QoS profile.

In step 517, admission control may be performed by the target RAN node 554. The target RAN node 554 may prepare the handover and may send the HANDOVER REQUEST ACKNOWLEDGE 518 to the source RAN node 552, which may include information (e.g., in a transparent container) to be sent to the WTRU 550 as an RRC message to perform the handover.

Prior to interruption time 522, PDUs of first downlink PDU set 519 may arrive at the UPF 556 from the AS 564, and the UPF 556 may forward PDUs of first downlink PDU set 519 to the source RAN node 552. The source RAN node 552 may successfully transmit part of a PDU set 520 (e.g., first downlink PDU set 519) to WTRU 550 (e.g., first K PDUs of the PDU set). Hereinafter, this scenario will be referred to as the split PDU set.

The source RAN node 552 may trigger the handover by sending an RRCReconfiguration message 521 to the WTRU 550 including information to access the target RAN node 554. The WTRU 550 may disconnect with the source RAN node 552 and attempt to synchronize to the target RAN node 554.

In step 523, the source RAN node 552 may determine to use the secondary QoS profile for the split PDU set. As a result, the source RAN node 552 stops PDU set monitoring for this PDU set.

Step 526 includes steps 525 and 527. In step 525, the source RAN node 552 relays the remaining PDUs of the split PDU set (originally received from UPF 556) to the target RAN node 554. In step 527, based on the PDU set information, the target RAN node 554 may determine that the PDU set is a split PDU set. The target RAN node 554 may use the secondary QoS profile for this PDU set. The target RAN node 554 may not perform PDU set monitoring for this PDU set.

Step 530 includes steps 528, 529 and 531. A downlink PDU set 528 arrives at the UPF 556. The UPF 556 marks the DL PDU set 528 (DL traffic) with PDU set information and sends the marked PDUs 529 of the PDU set to the source RAN node 552, and the source RAN nodes relays the complete PDU set to the target RAN node 554. At step 531, based on the PDU set information, the target RAN node 554 may determine that the PDU set is a complete PDU set. The target RAN node 554 may use the primary QoS profile for this PDU set.

The WTRU 550 connects to the target RAN node 554 and completes the handover procedure by sending RRCReconfigurationComplete message 532 to target RAN node 554. The target RAN node 554 transmits relayed PDUs 534 to the WTRU 550.

A path switch exchange 535 occurs, where the target RAN node 554 may send a PATH SWITCH REQUEST message to the AMF (not shown), which may trigger the user plane path to switch from the UPF 556 connection to the source RAN node 552 to a UPF 556 connection to the target RAN node 554. As part of path switch exchange 535, the target RAN node 554 may receive a PATH SWITCH REQUEST ACKNOWLEDGE. The target RAN node 554 may send a request to the source RAN node 552 to release all context related to the WTRU 550 (e.g., WTRU CONTEXT RELEASE message 536). Subsequently, the WTRU 550 communicates over target RAN node 554, such that DL PDU sets 537 from AS 564 flow through target RAN node 554, and are forwarded as DL PDU sets 538 to WTRU 550. Similarly, UL PDU sets 539 are sent to target RAN node 554, which forwards as UL PDU sets 540 to AS 564.

The example mobility handling procedure 500 is based on using a primary (or default) QoS profile and a secondary (or split-PDU set) QoS profile. The primary QoS profile has PDU set QoS parameters and triggers the RAN nodes to perform PDU set monitoring. The secondary QoS profile should be applied only to PDU sets that are split, for example because of handover. This secondary QoS profile does not have PDU set QoS parameters and does not trigger PDU set monitoring in the RAN nodes. Both the primary QoS profile and secondary QoS profile are configured in the RAN nodes. In an alternative not shown, the secondary QoS profile may be derived implicitly from the primary QoS profile. In this alternative, the secondary QoS profile will have a subset of the QoS parameters of the primary QoS profile. The secondary QoS profile may be made up of only those QoS parameters that are not PDU set based. For example, if the primary QoS profile has a PSDB value, the secondary QoS profile would not have this PSDB value.

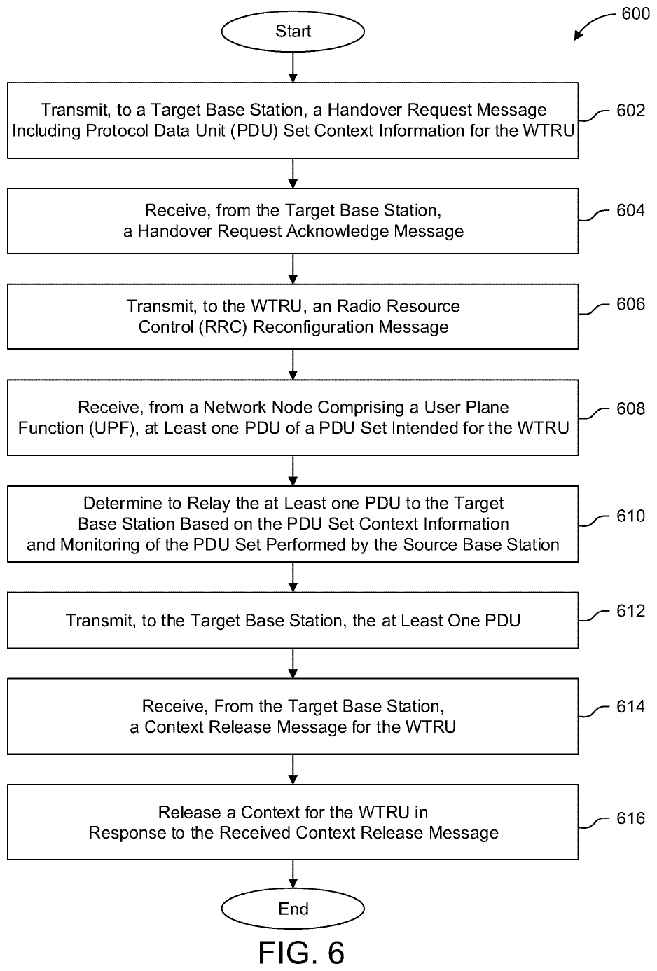

FIG. 6 is a flow diagram illustrating another example mobility handling procedure 600 for user data with PDU sets intended for a WTRU, which may be performed by a source base station. At 602, the source base station may transmit, to a target base station, a handover request message including protocol data unit (PDU) set context information for the WTRU. At 604, the source base station may receive, from the target base station, a handover request acknowledge message. At 606, the source base station may transmit, to the WTRU, an radio resource control (RRC) reconfiguration message. At 608, the source base station may receive, from a network node comprising a user plane function (UPF), at least one PDU of a PDU set intended for the WTRU. At 610, the source base station may determine to relay the at least one PDU to the target base station based on the PDU set context information and monitoring of the PDU set performed by the source base station. At 612, the source base station may transmit, to the target base station, the at least one PDU. At 614, the source base station may receive, from the target base station, a context release message for the WTRU. At 616, the source base station may release a context for the WTRU in response to the received context release message.

Additionally, any of the following (not shown) may (or may not) be used with procedure 600. The determination to relay the at least one PDU to the target base station may be further based on quality of service (QoS) parameters of the PDU set. The PDU set context information may include one or more of the following: PDU set delay budget (PSDB) information, PDU set error rate (PSER) information, or content ratio information. The source base station may transmit, to the network node comprising the UPF in response to the received handover request acknowledge message, a pending handover message including an identifier for the WTRU. The source base station may receive, from a network node comprising a session management function, a quality of service (QoS) profile including an indication of a PDU set mobility option to use for the WTRU. The source base station may determine when to trigger a handover for the WTRU based on at least one of: measurement reports, radio resource management (RRM) information, or the indication of the PDU set mobility option to use for the WTRU. The indication of the PDU set mobility option to use for the WTRU indicates one of the following: delay handover, early handover, split PDU set, or split PDU set after content ratio requirement met. The indication of the PDU set mobility option to use for the WTRU has one of the following granularities: per PDU session, per QoS flow, per service data flow (SDF), or per PDU set.

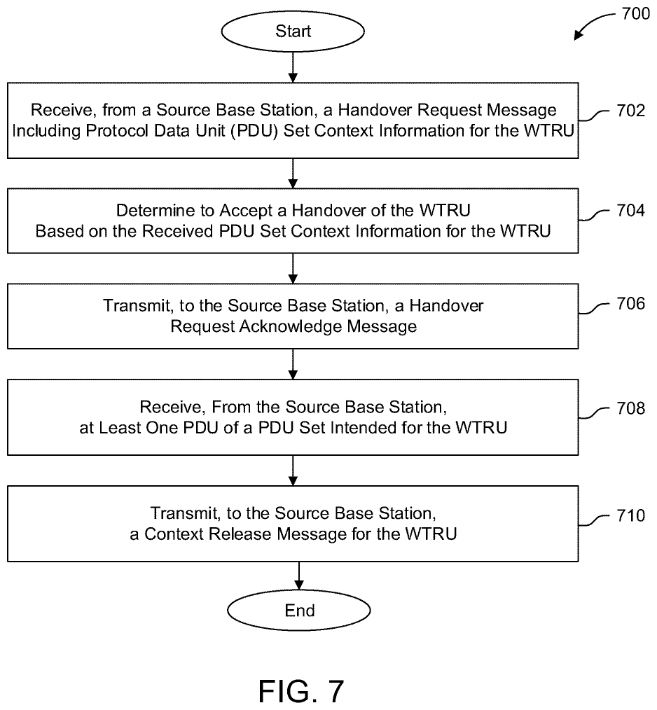

FIG. 7 is a flow diagram illustrating another example mobility handling procedure 700 for user data with PDU sets intended for a WTRU, which may be performed by a target base station. At 702, the target base station may receive, from a source base station, a handover request message including protocol data unit (PDU) set context information for the WTRU. At 704, the target base station may determine to accept a handover of the WTRU based on the received PDU set context information for the WTRU. At 706, the target base station may transmit, to the source base station, a handover request acknowledge message. At 708, the target base station may receive, from the source base station, at least one PDU of a PDU set intended for the WTRU. At 710, the target base station may transmit, to the source base station, a context release message for the WTRU.

Additionally, any of the following (not shown) may (or may not) be used with procedure 700. The PDU set context information may include one or more of the following: PDU set delay budget (PSDB) information, PDU set error rate (PSER) information, or content ratio information. The handover request message may further include one or more quality of service (QoS) flow level QoS profiles. The target base station may transmit, to a network node comprising a user plane function (UPF), a pending handover message including an identifier for the WTRU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A source base station for a wireless transmit/receive unit (WTRU), the source base station comprising:
a transceiver; and
a processor, wherein the transceiver and the processor are configured to:
transmit, to a target base station, a handover request message including protocol data unit (PDU) set context information for the WTRU;
receive, from the target base station, a handover request acknowledge message;
transmit, to the WTRU, an radio resource control (RRC) reconfiguration message;
receive, from a network node comprising a user plane function (UPF), at least one PDU of a PDU set intended for the WTRU;
determine to relay the at least one PDU to the target base station based on the PDU set context information and monitoring of the PDU set performed by the source base station;
transmit, to the target base station, the at least one PDU;
receive, from the target base station, a context release message for the WTRU; and
release a context for the WTRU in response to the received context release message.

2. The source base station of claim 1, wherein the determination to relay the at least one PDU to the target base station is further based on quality of service (QoS) parameters of the PDU set.

3. The source base station of claim 1, wherein the PDU set context information includes one or more of the following: PDU set delay budget (PSDB) information, PDU set error rate (PSER) information, or content ratio information.

4. The source base station of claim 1, wherein the transceiver and the processor are further configured to:
transmit, to the network node comprising the UPF in response to the received handover request acknowledge message, a pending handover message including an identifier for the WTRU.

5. The source base station of claim 1, wherein the transceiver and the processor are further configured to:
receive, from a network node comprising a session management function, a quality of service (QoS) profile including an indication of a PDU set mobility option to use for the WTRU.

6. The source base station of claim 5, wherein the transceiver and the processor are further configured to:
determine when to trigger a handover for the WTRU based on at least one of: measurement reports, radio resource management (RRM) information, or the indication of the PDU set mobility option to use for the WTRU.

7. The source base station of claim 5, wherein the indication of the PDU set mobility option to use for the WTRU indicates one of the following: delay handover, early handover, split PDU set, or split PDU set after content ratio requirement met.

8. The source base station of claim 5, wherein the indication of the PDU set mobility option to use for the WTRU has one of the following granularities: per PDU session, per QoS flow, per service data flow (SDF), or per PDU set.

9. A method performed by a source base station for a wireless transmit/receive unit (WTRU), the method comprising:
transmitting, to a target base station, a handover request message including protocol data unit (PDU) set context information for the WTRU;
receiving, from the target base station, a handover request acknowledge message;
transmitting, to the WTRU, an radio resource control (RRC) reconfiguration message;
receiving, from a network node comprising a user plane function (UPF), at least one PDU of a PDU set intended for the WTRU;
determining to relay the at least one PDU to the target base station based on the PDU set context information and monitoring of the PDU set performed by the source base station;
transmitting, to the target base station, the at least one PDU;
receiving, from the target base station, a context release message for the WTRU; and
releasing a context for the WTRU in response to the received context release message.

10. The method of claim 9, wherein the determination to relay the at least one PDU to the target base station is further based on quality of service (QoS) parameters of the PDU set.

11. The method of claim 9, wherein the PDU set context information includes one or more of the following: PDU set delay budget (PSDB) information, PDU set error rate (PSER) information, or content ratio information.

12. The method of claim 9, further comprising:
transmitting, to the network node comprising the UPF in response to the received handover request acknowledge message, a pending handover message including an identifier for the WTRU.

13. The method of claim 9, further comprising:
receiving, from a network node comprising a session management function, a quality of service (QoS) profile including an indication of a PDU set mobility option to use for the WTRU.

14. The method of claim 13, further comprising:
determining when to trigger a handover for the WTRU based on at least one of: measurement reports, radio resource management (RRM) information, or the indication of the PDU set mobility option to use for the WTRU.

15. The method of claim 13, wherein the indication of the PDU set mobility option to use for the WTRU indicates one of the following: delay handover, early handover, split PDU set, or split PDU set after content ratio requirement met.

16. The method of claim 13, wherein the indication of the PDU set mobility option to use for the WTRU has one of the following granularities: per PDU session, per QoS flow, per service data flow (SDF), or per PDU set.

17. A target base station for a wireless transmit/receive unit (WTRU), the target base station comprising:
a transceiver; and
a processor, wherein the transceiver and the processor are configured to:
receive, from a source base station, a handover request message including protocol data unit (PDU) set context information for the WTRU;
determine to accept a handover of the WTRU based on the received PDU set context information for the WTRU;
transmit, to the source base station, a handover request acknowledge message;
receive, from the source base station, at least one PDU of a PDU set intended for the WTRU; and
transmit, to the source base station, a context release message for the WTRU.

18. The target base station of claim 17, wherein the PDU set context information includes one or more of the following: PDU set delay budget (PSDB) information, PDU set error rate (PSER) information, or content ratio information.

19. The target base station of claim 17, wherein the handover request message further includes one or more quality of service (QoS) flow level QoS profiles.

20. The target base station of claim 17, wherein the transceiver and the processor are further configured to:
transmit, to a network node comprising a user plane function (UPF), a pending handover message including an identifier for the WTRU.
